(19) United States
(12) Patent Application Publication
(10) Pub. No.: US 2017/0036488 A1
(43) Pub. Date: Feb. 9, 2017

(54) Pneumatic Tire

(71) Applicant: The Yokohama Rubber Co., LTD., Minato-ku, Tokyo (JP)

(72) Inventor: Yasuhiro Takahashi, Hiratsuka-shi, Kanagawa (JP)

(21) Appl. No.: 15/305,081

(22) PCT Filed: Apr. 9, 2015
(86) PCT No.: PCT/JP2015/061104

§ 371 Date: Oct. 18, 2016

(30) Foreign Application Priority Data
Apr. 22, 2014 (JP) 2014-088003

(51) Int. Cl. B60C 11/03; B60C 11/13; B60C 11/12

(52) U.S. Cl. CPC B60C 11/0304; B60C 11/1236; B60C 11/1384; B60C 11/0302; B60C 11/1353; B60C 11/0306; B60C 11/1204; B60C 2011/0341; B60C 2011/0358; B60C 2011/0374; B60C 2011/1361

(57) ABSTRACT

A pneumatic tire has a tread pattern which includes a center land portion between a first outer circumferential groove disposed outward of a tire center line in a tire width direction and a first inner circumferential groove disposed inward of the tire center line in the tire width direction, an outer land portion between the first outer circumferential groove and a second outer circumferential groove disposed outward of the first outer circumferential groove in the tire width direction, and an outer shoulder land portion disposed outward of the second outer circumferential groove in the tire width direction, the center land portion. The outer land portion, and the outer shoulder land portion are continuous land portions which are continuous in an annular manner in a tire circumferential direction.

### TECHNICAL FIELD

The present technology relates to a pneumatic tire having a tread pattern formed in a tread portion.

### BACKGROUND ART

Grooves are formed in a tread portion of a pneumatic tire to increase its wet performance. Though a large groove area ratio is vital to improving wet performance, if the groove area ratio is too large, the ground contact area may decrease, thus reducing the grip and steering stability of the tire.

To attempt to fulfill such competing requirements, research and development associated with the width and number of tire circumferential grooves provided in the tread portion and the inclination angle and width of lug grooves have been performed (see, for example, Japanese Unexamined Patent Application Publication No. 2013-139241A).

By forming a land portion between circumferential grooves of a pneumatic tire as a rib continuous in the tire circumferential direction, the rigidity of the land portion is increased, and thus steering stability on dry road surfaces is increased. However, braking performance is decreased due to a reduction in the number of edges.

On the other hand, by forming a land portion between circumferential grooves as blocks divided in the tire circumferential direction, the number of edges is increased, and thus braking performance is increased. However, steering stability is decreased due to a reduction in rigidity of the land portion.

### SUMMARY

The present technology provides a pneumatic tire that can achieve both good steering stability and braking performance.

One aspect of the present technology is a pneumatic tire with a tread pattern formed in a tread portion and a specified first side and second side in a tire width direction, the first side being a vehicle outer side when the tire is mounted on a vehicle and the second side being a vehicle inner side.

The tread pattern includes

a first outer circumferential groove which is located to the first side of a tire center line and runs parallel with a tire circumferential direction;

a second outer circumferential groove which is located to the first side of the first outer circumferential groove and runs parallel with the tire circumferential direction;

a first inner circumferential groove which is located to the second side of the tire center line and runs parallel with the tire circumferential direction;

a second inner circumferential groove which is located to the second side of the first inner circumferential groove and runs parallel with the tire circumferential direction;

a first lug groove group including a plurality of first lug grooves which divide in the tire circumferential direction an inner land portion located between the first inner circumferential groove and the second inner circumferential groove; and

a second lug groove group including a plurality of second lug grooves which divide in the tire circumferential direction an inner shoulder land portion located inward in the tire width direction of the second inner circumferential groove;

a center land portion located between the first outer circumferential groove and the first inner circumferential groove, an outer land portion located between the first outer circumferential groove and the second outer circumferential groove, and an outer shoulder land portion located outward of the second outer circumferential groove in the tire width direction being continuous land portions which are continuous in an annular manner in the tire circumferential direction.

The pneumatic tire preferably further includes a third lug groove group including a plurality of third lug grooves, each of the third lug grooves having a starting end located between the first outer circumferential groove and the first inner circumferential groove and spaced apart from the first outer circumferential groove and the first inner circumferential groove and communicating with the first inner circumferential groove; wherein

the third lug grooves of the third lug groove group differ from each other in terms of at least one of length in the tire width direction, width in the tire circumferential direction, and depth in a tire radial direction.

The pneumatic tire preferably further includes a fourth lug groove group including a plurality of fourth lug grooves, each of the fourth lug grooves having a starting end located between the first outer circumferential groove and the second outer circumferential groove and spaced apart from the first outer circumferential groove and the second outer circumferential groove and communicating with the second outer circumferential groove; wherein

the fourth lug grooves of the fourth lug groove group differ from each other in terms of at least one of length in the tire width direction, width in the tire circumferential direction, and depth in a tire radial direction.

The pneumatic tire preferably further includes a fifth lug groove group including a plurality of fifth lug grooves, each of the fifth lug grooves having a starting end located between the first inner circumferential groove and the second inner circumferential groove and spaced apart from the first inner circumferential groove, the second inner circumferential groove, and the first lug grooves and communicating with the second inner circumferential groove.

The pneumatic tire preferably further includes a sixth lug groove group including a plurality of sixth lug grooves, each of the sixth lug grooves having a starting end located spaced outwardly apart from the second outer circumferential groove in the tire width direction and extending outward in the tire width direction.

The pneumatic tire preferably has a configuration wherein in the inner land portion, a corner portion with an acute angle is formed between the first inner circumferential groove or the second inner circumferential groove and the first lug groove; and

in the corner portion with an acute angle, an inclined surface is formed by chamfering, the inclined surface meeting a road contact surface of the inner land portion, a side wall of the first inner circumferential groove or the second inner circumferential groove, and a side wall of the first lug groove.

The pneumatic tire preferably has a configuration wherein in the center land portion, a corner portion with an acute angle is formed between the first inner circumferential groove and the third lug groove; and

in the corner portion with an acute angle, an inclined surface is formed by chamfering, the inclined surface meeting a road contact surface of the center land portion, a side wall of the first inner circumferential groove, and a side wall of the third lug groove.

The pneumatic tire preferably has a configuration wherein in the outer land portion, a corner portion with an acute angle is formed between the second outer circumferential groove and the fourth lug groove; and

in the corner portion with an acute angle, an inclined surface is formed by chamfering, the inclined surface meeting a road contact surface of the outer land portion, a side wall of the second outer circumferential groove, and a side wall of the fourth lug groove.

The pneumatic tire preferably has a configuration wherein in the inner land portion, a corner portion with an acute angle is formed between the second inner circumferential groove and the fifth lug groove; and

in the corner portion with an acute angle, an inclined surface is formed by chamfering, the inclined surface meeting a road contact surface of the inner land portion, a side wall of the second inner circumferential groove, and a side wall of the fifth lug groove.

The pneumatic tire preferably has a configuration wherein in the second outer circumferential groove, notches are disposed at positions in the tire circumferential direction that correspond to inner starting ends of the sixth lug grooves in the tire width direction, the notches recessing outward in the tire width direction from an outer side wall of the second outer circumferential groove in the tire width direction and being spaced inwardly apart from the inner starting ends of the sixth lug grooves in the tire width direction.

The pneumatic tire preferably has a configuration wherein

the fourth lug groove group includes a long lug groove and a short lug groove with a length in the tire width direction less than that of the long lug groove, the long lug groove and the short lug groove being alternately arranged in the tire circumferential direction; and further including

first sipes which communicate with starting ends of the short lug grooves and the first outer circumferential groove and define the outer land portion in the tire circumferential direction, each of the first sipes including:

a bent portion disposed between the starting end of the short lug groove and the first outer circumferential groove,

a first linear portion which extends in a first direction in a tire rotation direction inward in the tire width direction from the starting end of the short lug groove to the bent portion, and

a second linear portion which extends in a second direction opposite to the first direction in a tire rotation direction inward in the tire width direction from the bent portion to an end portion proximal to the first outer circumferential groove, and

each portion of the outer land portion defined in the tire circumferential direction by the first sipes includes a convex portion which protrudes in the first direction of the tire rotation direction.

The pneumatic tire preferably further includes second sipes which extend from the second outer circumferential groove to an outer ground contact edge in the tire width direction, define the outer shoulder land portion in the tire circumferential direction, and have a curved line shape which includes a plurality of bent portions in a tread surface; and wherein each portion of the outer shoulder land portion defined in the tire circumferential direction by the second sipes includes a convex portion which protrudes in the first direction of a tire rotation direction.

The pneumatic tire preferably further includes a seventh lug groove group including a plurality of seventh lug grooves, each of the seventh lug grooves having a starting end located between the second lug grooves in the tire circumferential direction and spaced inwardly apart from the second inner circumferential groove in the tire width direction, and extending inward in the tire width direction; and

third sipes which communicate with the starting ends of the seventh lug grooves and the second inner circumferential groove, each of the third sipes including:

a bent portion disposed between the starting end of the seventh lug groove and the second inner circumferential groove,

a first linear portion which extends in the second direction opposite to the first direction in a tire rotation direction outward in the tire width direction from the starting end of the seventh lug groove to the bent portion, and

a second linear portion which extends in the first direction in the tire rotation direction outward in the tire width direction from the bent portion to an end portion proximal to the second inner circumferential groove, and

each portion of the inner shoulder land portion defined in the tire circumferential direction by the third sipes includes a convex portion which protrudes in the second direction of the tire rotation direction.

The pneumatic tire preferably further includes fourth sipes which communicate with the starting ends of the third lug grooves and the first outer circumferential groove.

The pneumatic tire preferably further includes fifth sipes disposed between the first inner circumferential groove and the second inner circumferential groove which intersect with the first lug grooves.

The pneumatic tire preferably has a configuration wherein

a tire rotation direction is predetermined, and each of the first lug grooves include:

a first inclined portion which extends toward a trailing side in the tire rotation direction inward in the tire width direction from the first inner circumferential groove,

a second inclined portion which extends toward the trailing side in the tire rotation direction outward in the tire width direction from the second inner circumferential groove, and

a bent portion where the first inclined portion and the second inclined portion meet.

The pneumatic tire preferably has a configuration wherein a distance in the tire width direction from the bent portion to the first inner circumferential groove is less than a distance in the tire width direction from the bent portion to the second inner circumferential groove.

The pneumatic tire preferably has a configuration wherein the second inclined portion and the bent portion are raised bottom portions with a groove depth less than that of the first inclined portion.

The pneumatic tire preferably has a configuration wherein in the second inclined portion and the bent portion, a sixth sipe is disposed in a length direction of the first lug groove.

The pneumatic tire preferably has a configuration wherein in an end portion of each second lug groove proximal to the second inner circumferential groove, a raised bottom portion is disposed, the raised bottom portion being shallower than other portions of the second lug groove.

According to the aspects described above, both good steering stability and braking performance can be achieved.

### BRIEF DESCRIPTION OF DRAWINGS

FIG. 1 is a cross-sectional view of a pneumatic tire of a first embodiment of the present technology.

FIG. 2 is a developed view illustrating a tread pattern 30A of the pneumatic tire of the first embodiment.

FIG. 3 is a developed view illustrating a tread pattern 30B of a pneumatic tire of a second embodiment.

FIG. 4 is a developed view illustrating a tread pattern 30C of a pneumatic tire of a third embodiment.

### DETAILED DESCRIPTION

Embodiments of the present technology will be described below in detail with reference to the drawings.

### First Embodiment

### Overall Explanation of the Tire

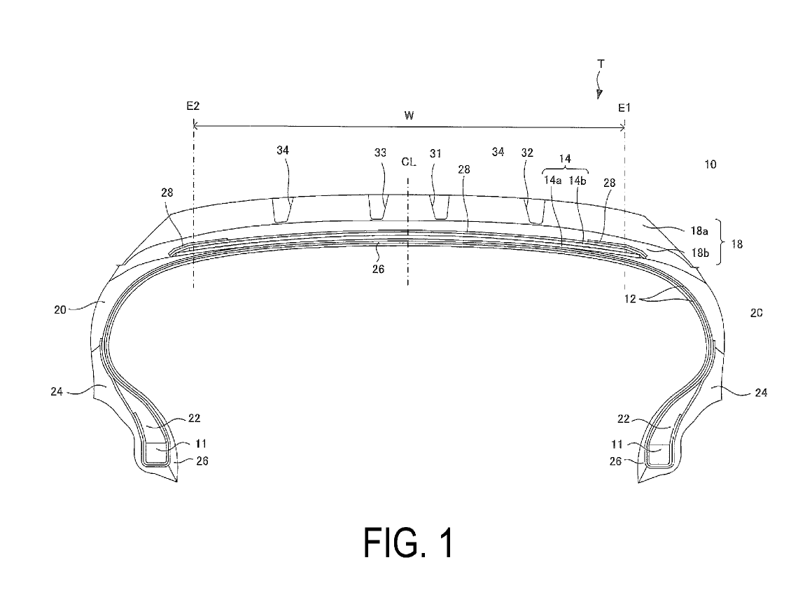

Below, a pneumatic tire of the present embodiment is described. FIG. 1 is a tire cross-sectional view illustrating a cross section of a pneumatic tire (hereinafter referred to as “tire”) 10 of the present embodiment.

The tire 10 is, for example, a tire for a passenger vehicle. A tire for a passenger vehicle refers to a tire defined according to Chapter A of the JATMA Yearbook 2012 (standards of The Japan Automobile Tyre Manufacturers Association, Inc.). The tire 10 can also be a small truck tire as defined in Chapter B or a truck tire or bus tire as defined in Chapter C.

Below, values of the dimensions of various pattern elements are described in detail as example values for a tire for a passenger vehicle. However, the pneumatic tire of the present technology is not limited to these example values.

The “tire circumferential direction” described below refers to the direction (both directions) the tread surface rotates when the tire 10 rotates about the tire rotation axis. The “tire radial direction” refers to the direction that extends radially orthogonal to the tire rotation axis. “Outward in the tire radial direction” refers to the side outward from the tire rotation axis in the tire radial direction. The “Tire width direction” refers to the direction parallel to the tire rotation axis direction. “Outward in the tire width direction” refers to an outer side outward from the center line CL of the tire 10.

### Tire Structure

The tire 10 mainly includes a pair of bead cores 11, a carcass ply layer 12, and a belt layer 14 as tire skeleton members, and around these tire skeleton members, a tread rubber member 18, sidewall rubber members 20, bead filler rubber members 22, rim cushion rubber members 24, and an innerliner rubber member 26 are included.

The pair of bead cores 11 are annular members disposed at the end portions in the tire width direction, inward in the tire radial direction.

The carcass ply layer 12 includes one or more carcass ply members 12a, 12b, which are made of organic fibers covered with rubber. The carcass ply members 12a, 12b extend between and around the pair of bead cores 11 to form a toroidal form.

The belt layer 14 includes a plurality of belt members 14a, 14b. The belt layer 14 is wound in the tire circumferential direction outward of the carcass ply layer 12 in the tire radial direction. The inward belt member 14a in the tire radial direction has a width in the tire width direction greater than the width of the outward belt member 14b in the tire radial direction.

The belt members 14a, 14b are members made of steel cords covered with rubber. The steel cords of the belt members 14a, 14b are disposed inclined at a predetermined angle of from, for example, 20 degrees to 30 degrees, with respect to the tire circumferential direction. The steel cords of the belt members 14a, 14b are inclined in the directions opposite to one another with respect to the tire circumferential direction and cross one another. The belt layer 14 minimizes or prevents expansion of the carcass ply layer 12 caused by the pressure of the air in the tire 10.

The tread rubber member 18 is disposed outward of the belt layer 14 in the tire radial direction. The sidewall rubber members 20 are connected to both end portions of the tread rubber member 18. The tread rubber member 18 is made of two layers: an upper layer tread rubber member 18a disposed outward in the tire radial direction and a lower layer tread rubber member 18b disposed inward in the tire radial direction. The rim cushion rubber members 24 are provided at the inward ends of the sidewall rubber members 20 in the tire radial direction. The rim cushion rubber members 24 come into contact with the rim on which the tire 10 is mounted. The bead filler rubber members 22 are disposed outward of the bead core 11 in the tire radial direction so as to be interposed between the carcass ply layer 12 wound around the bead core 11. The innerliner rubber member 26 is disposed on an inner surface of the tire 10 facing a tire cavity region that is filled with air and is surrounded by the tire 10 and the rim.

In addition, the tire 10 is provided with a belt cover layer 28 that covers the outward surface of the belt layer 14 in the tire radial direction. The belt cover layer 28 is made of organic fibers covered with rubber.

The tire 10 has the tire structure illustrated in FIG. 1. However, the pneumatic tire of the present technology is not limited to this structure.

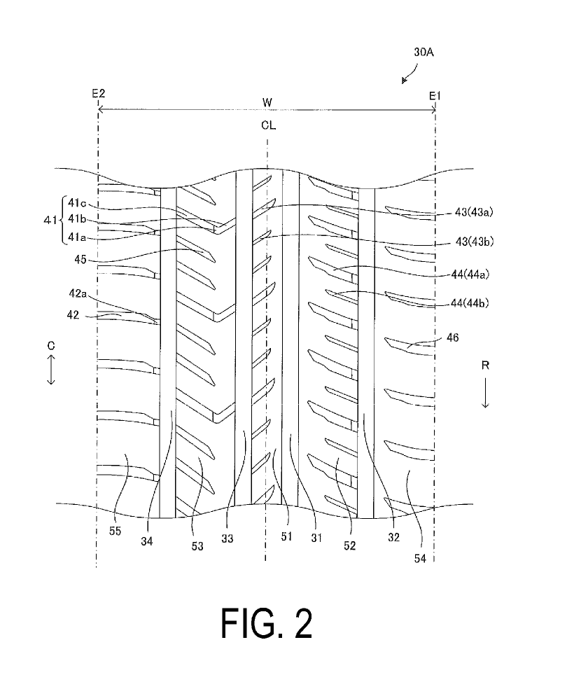

FIG. 2 is a developed view illustrating a tread pattern 30A of the pneumatic tire 10. The tire 10 of the present technology has the tread pattern 30A as a feature of the present technology formed in the tread portion T as illustrated in FIG. 2. The tire 10 having the tread pattern 30A may be suitably used as a tire for a passenger vehicle.

The tire rotation direction of the tire 10 of the present embodiment is predetermined, and the tire 10 is fitted to a vehicle so that the tire 10 rotates in the tire rotation direction R in FIG. 2 when the vehicle is moving forward. Symbols and information indicating this rotational moving direction are displayed on the surfaces of the sidewall rubber members 20 of the tire 10. When the tire 10 rotates in the tire rotation direction R, the tread portion T moves in rotation from bottom to top in FIG. 2, and the position where the tread portion T comes into contact with the road surface moves from top to bottom in FIG. 2. In other words, the upper side of FIG. 2 is the leading side in the tire rotation direction (first direction in the tire rotation direction) and the lower side of FIG. 2 is the trailing side in the tire rotation direction (second direction in the tire rotation direction).

In the present embodiment, the “tire circumferential direction C” refers to the rotation direction R of the tire 10 and the reverse direction thereof, and is a direction perpendicular to the page of FIG. 1 and the up-down direction of FIG. 2.

Additionally, the tire 10 of the present embodiment has a predetermined first side and a second side in relation to the vehicle when the tire 10 is mounted. The first side corresponds to the vehicle outer side in the tire width direction and the second side corresponds to the vehicle inner side. Symbols and information indicating this direction for mounting to the rim of a vehicle are displayed on a direction specifying portion provided on the surfaces of the sidewall rubber members 20 of the tire 10. In FIG. 1 and FIG. 2, the right side is the first side (outer side in the tire width direction) corresponding to the vehicle outer side in the tire width direction when the tire 10 is mounted on a vehicle. The left side is the second side (inner side in the tire width direction) corresponding to the vehicle inner side. In the present embodiment, the “tire width direction” refers to the rotation axis direction of the tire 10 and is the left-right direction in FIG. 1 and FIG. 2.

In FIG. 2, the reference sign CL denotes the tire center line. While the tire 10 is mounted on a vehicle, the tread pattern 30A comes into contact with the road surface in a region of the tire width direction indicated by a ground contact width W.

Here, the interval between the outer ground contact edge E1 and the inner ground contact edge E2 is the ground contact width W. The ground contact edges E1, E2 are both end portions in the tire width direction of the ground contact patch when the tire 10 is brought into contact with a horizontal surface under conditions in which the tire 10 is fitted to a specified rim and is inflated to the specified internal pressure, and a load of 80% of the specified load is applied.

The tread pattern 30A illustrated in FIG. 2 is provided with a first outer circumferential groove 31, a second outer circumferential groove 32, a first inner circumferential groove 33, a second inner circumferential groove 34, a first lug groove group including a plurality of first lug grooves 41, a second lug groove group including a plurality of second lug grooves 42, a third lug groove group including a plurality of third lug grooves 43, a fourth lug groove group including a plurality of fourth lug grooves 44, a fifth lug groove group including a plurality of fifth lug grooves 45, a sixth lug groove group including a plurality of sixth lug grooves 46.

The first outer circumferential groove 31, the second outer circumferential groove 32, the first inner circumferential groove 33, and the second inner circumferential groove 34 extend in an annular manner in the tire circumferential direction. The first outer circumferential groove 31 is disposed outward of the tire center line CL in the tire width direction. The second outer circumferential groove 32 is disposed between the first outer circumferential groove 31 and the outer ground contact edge E1. The first inner circumferential groove 33 is disposed inward of the tire center line CL in the tire width direction. The second inner circumferential groove 34 is disposed between the first inner circumferential groove 33 and the inner ground contact edge E2.

The first outer circumferential groove 31, the second outer circumferential groove 32, the first inner circumferential groove 33, and the second inner circumferential groove 34 preferably have a depth of, for example, from 8 mm to 10 mm, and a width of, for example, from 9 mm to 10 mm.

The plurality of first lug grooves 41 are disposed between the first inner circumferential groove 33 and the second inner circumferential groove 34 at intervals in the tire circumferential direction and communicate with the first inner circumferential groove 33 and the second inner circumferential groove 34. An inner land portion 53 located between the first inner circumferential groove 33 and the second inner circumferential groove 34 is divided in the tire circumferential direction to form blocks by the first lug grooves 41 which communicate with the first inner circumferential groove 33 and the second inner circumferential groove 34.

Each first lug groove 41 includes a bent portion 41a, a first inclined portion 41b, and a second inclined portion 41c. The bent portion 41a is disposed between the first inner circumferential groove 33 and the second inner circumferential groove 34. The position of the bent portion 41a in the tire width direction is preferably nearer to the first inner circumferential groove 33 than to the second inner circumferential groove 34. The ratio of the distance from the first inner circumferential groove 33 to the bent portion 41a to the width of the inner land portion 53 is preferably from 60% to 70%.

The first inclined portion 41b is disposed extending toward the trailing side in the tire rotation direction and inward in the tire width direction from the end portion of the first lug groove 41 proximal to the first inner circumferential groove 33 to the bent portion 41a. The first inclined portion 41b is preferably disposed aligned with the extension direction of the third lug groove 43a.

The second inclined portion 41c is disposed extending toward the trailing side in the tire rotation direction and outward in the tire width direction from the end portion of the first lug groove 41 proximal to the second inner circumferential groove 34 to the bent portion 41a.

The angle formed between the first inclined portion 41b and the tire width direction is preferably from 20 degrees to 30 degrees. Additionally, the angle formed between the second inclined portion 42c and the tire width direction is preferably from 20 degrees to 30 degrees. Furthermore, the angle formed between the first inclined portion 41b and the second inclined portion 41c is preferably from 100 degrees to 130 degrees. With this configuration, snow pushed into the first lug groove 41 by the rotation of the tire is compacted in the void between the first lug groove 41 from the end portion proximal to the second inner circumferential groove 34 to the bent portion 41a and the road surface. As a result, snow column shear force can be increased.

In the present embodiment, the bent portion 41a and the first inclined portion 41b of the first lug groove 41 include a raised bottom portion with a depth less than that of the second inclined portion 41c. Specifically, the bent portion 41a and the first inclined portion 41b of the first lug groove 41 preferably have a depth from 20% to 30% of the depth of the second inclined portion 41c. For example, when the depth of the second inclined portion 41c is from 6 mm to 8 mm, the depth of the bent portion 41a and the first inclined portion 41b is preferably from 1 mm to 3 mm. The first lug groove preferably has a width from 3 mm to 6 mm, for example.

The second inclined portion 41c extends toward the trailing side in the tire rotation direction from the end portion of the first lug groove 41 proximal to the second inner circumferential groove 34 to the bent portion 41a. Additionally, the bent portion 41a and the first inclined portion 41b have a depth that is less than that of the second inclined portion 41c. Accordingly, snow pushed into the second inclined portion 41c from the end portion proximal to the second inner circumferential groove 34 by the rotation of the tire is compacted between the second inclined portion 41c and the road surface. As a result, snow column shear force can be increased.

The second lug grooves 42 are disposed extending inward in the tire width direction from the second inner circumferential groove 34. The angle formed between the second lug grooves 42 and the tire width direction is preferably from 1 degree to 5 degrees. The second lug grooves 42 communicate with the second inner circumferential groove 34 and extend inward of the inner ground contact edge E2 in the tire width direction. Thus, an inner shoulder land portion 55 located inward of the second inner circumferential groove 34 in the tire width direction is divided into blocks in the tire circumferential direction by the second lug grooves 42. As a result, the edges formed by the second lug grooves 42 enable braking performance to be improved.

Note that, in each second lug groove 42, a raised bottom portion 42a shallower than other portions of the second lug groove 42 may be provided at the end portion proximal to the second inner circumferential groove 34. Providing the raised bottom portion 42a enables rigidity of the blocks of the inner shoulder land portion 55 divided in the tire circumferential direction by the second lug grooves 42 to be increased. Specifically, the raised bottom portion 42a of the second lug groove 42 preferably has a depth from 20% to 30% of the depth of the other portions of the second lug groove 42. For example, when the depth of the raised bottom portion 42a is from 1 mm to 3 mm, the depth of the other portions of the second lug groove 42 is preferably from 6 mm to 8 mm.

The plurality of third lug grooves 43 (43a, 43b ) are disposed at intervals in the tire circumferential direction. Each third lug groove 43 has a starting end positioned between the first outer circumferential groove 31 and the first inner circumferential groove 33 and spaced apart from the first outer circumferential groove 31 and the first inner circumferential groove 33, and extends to the trailing side in the tire rotation direction inward in the tire width direction to communicate with the first inner circumferential groove 33. The starting end of each third lug groove 43 is spaced apart from the first outer circumferential groove 31, thus a center land portion 51 located between the first outer circumferential groove 31 and the first inner circumferential groove 33 is formed as an annular rib continuous in the tire circumferential direction. As a result, rigidity of the center land portion 51 can be increased, thus enabling steering stability to be increased.

The third lug groove 43 extends from the starting end toward the trailing side in the tire rotation direction and communicates with the first inner circumferential groove 33. Thus, water between the third lug groove 43 and the road surface can be discharged to the first inner circumferential groove 33 by the rotation of the tire. To ensure water drainage performance, the angle formed between the third lug groove 43 and the tire width direction is preferably from 30 degrees to 45 degrees.

The third lug groove group preferably includes third lug grooves 43 that are different in terms of at least one of length in the tire width direction, width in the tire circumferential direction, and depth in the tire radial direction. Note that in FIG. 2, third lug grooves 43a and third lug grooves 43b, which differ in terms of length in the tire width direction, width in the tire circumferential direction, and depth in the tire radial direction, are illustrated. The third lug grooves 43a are disposed opposed to the first lug grooves 41 on the other side of the first inner circumferential groove 33. The third lug grooves 43a have a greater length in the tire width direction, width in the tire circumferential direction, and depth in the tire radial direction than the third lug groove 43b. Specifically, the third lug grooves 43a preferably have a length in the tire width direction of from 12 mm to 20 mm and the third lug grooves 43b from 9 mm to 16 mm. The third lug grooves 43a preferably have a width in the tire circumferential direction of from 4 mm to 6 mm and the third lug grooves 43b from 2 mm to 3 mm. The third lug grooves 43a preferably have a depth of from 2 mm to 4 mm and the third lug grooves 43b from 3 mm to 6 mm.

In the present embodiment, one of the third lug grooves 43a and two of the third lug grooves 43b are alternately arranged in the tire circumferential direction. By disposing two of the third lug grooves 43b, which are smaller in length in the tire width direction, width in the tire circumferential direction, and depth in the tire radial direction than the third lug grooves 43a, in between the third lug grooves 43a, which are greater in length in the tire width direction, width in the tire circumferential direction, and depth in the tire radial direction, strength of the center land portion 51 can be maintained.

The plurality of fourth lug grooves 44 are disposed at intervals in the tire circumferential direction. Each fourth lug groove 44 has a starting end positioned between the first outer circumferential groove 31 and the second outer circumferential groove 32 and spaced apart from the first outer circumferential groove 31 and the second outer circumferential groove 32, and extends to the trailing side in the tire rotation direction outward in the tire width direction to communicate with the second outer circumferential groove 32. The starting end of each fourth lug groove 44 is spaced apart from the first outer circumferential groove 31, thus an outer land portion 52 located between the first outer circumferential groove 31 and the second outer circumferential groove 32 is formed as an annular rib continuous in the tire circumferential direction. As a result, rigidity of the outer land portion 52 can be increased, thus enabling steering stability to be increased.

The fourth lug groove 44 extends from the starting end toward the trailing side in the tire rotation direction and communicates with the second outer circumferential groove 32. Thus, water between the fourth lug groove 44 and the road surface can be discharged to the second outer circumferential groove 32 by the rotation of the tire. To ensure water drainage performance, the angle formed between the fourth lug groove 44 and the tire width direction is preferably from 20 degrees to 40 degrees.

The fourth lug groove group preferably includes fourth lug grooves 44 that are different in terms of at least one of length in the tire width direction, width in the tire circumferential direction, and depth in the tire radial direction. Note that in FIG. 2, fourth lug grooves 44a and fourth lug grooves 44b, which differ in terms of length in the tire width direction, width in the tire circumferential direction, and depth in the tire radial direction, are illustrated. The fourth lug grooves 44a (long lug grooves) have a greater length in the tire width direction, width in the tire circumferential direction, and depth in the tire radial direction than the fourth lug grooves 44b (short lug grooves). Specifically, the fourth lug grooves 44a preferably have a length in the tire width direction of from 30 mm to 35 mm and the fourth lug grooves 44b from 20 mm to 25 mm. The fourth lug grooves 44a preferably have a width in the tire circumferential direction of from 5 mm to 7 mm and the fourth lug grooves 44b from 2 mm to 3 mm. The fourth lug grooves 44a preferably have a depth of from 1 mm to 7 mm and the fourth lug grooves 44b from 1 mm to 5 mm.

In the present embodiment, one of the fourth lug grooves 44a and one of the fourth lug grooves 44b are alternately arranged in the tire circumferential direction. By disposing one of the fourth lug grooves 44b, which are smaller in length in the tire width direction, width in the tire circumferential direction, and depth in the tire radial direction that the fourth lug grooves 44a, in between the fourth lug grooves 44a, which are greater in length in the tire width direction, width in the tire circumferential direction, and depth in the tire radial direction, strength of the outer land portion 52 can be maintained.

The interval between adjacent fourth lug grooves 44a in the tire circumferential direction is approximately half that of the interval between the first lug grooves 41 in the tire circumferential direction. In the present embodiment, the fourth lug grooves 44a are disposed alternately at the same positions as the first lug grooves 41 and at the positions in between adjacent first lug grooves 41 in the tire circumferential direction. Accordingly, the number of lug grooves in the outer land portion 52 is greater than the number of lug grooves in the inner land portion 53.

The plurality of fifth lug grooves 45 are disposed in a region enclosed by the first inner circumferential groove 33, the second inner circumferential groove 34, and the first lug grooves (third lug grooves) 41 and extend from starting ends at positions spaced apart from the first inner circumferential groove 33, the second inner circumferential groove 34, and the first lug grooves (third lug grooves) 41 toward the leading side in the tire rotation direction inward in the tire width direction to communicate with the second inner circumferential groove 34. Thus, snow pushed into the fifth lug grooves 45 from the end portion proximal to the second inner circumferential groove 34 by the rotation of the tire is compacted between the fifth lug grooves 45 and the road surface. As a result, snow column shear force can be increased.

In the present embodiment, the fifth lug grooves 45 are disposed at the same position as the third lug groove 43b in the tire circumferential direction.

In the present embodiment, the positions in the tire width direction of the starting ends of the fifth lug grooves 45 are either substantially equal to the positions in the tire width direction of the bent portions 41a of the first lug grooves 41 or inward of the bent portion 41a in the tire width direction. The second inclined portions 41c of the first lug grooves 41 and the fifth lug grooves 45 are disposed substantially in parallel. Specifically, the angle formed between the fifth lug grooves 45 and the tire width direction is preferably from 20 degree to 30 degrees.

The position in the tire width direction of the starting end of the fifth lug grooves 45 is preferably nearer to the first inner circumferential groove 33 than to the second inner circumferential groove 34. Specifically, the distance from the first inner circumferential groove 33 to the starting end of the fifth lug grooves 45 is preferably from 60% to 70% of the width of the inner land portion 53. The fifth lug grooves 45 preferably have a depth of from 6 mm to 8 mm, for example, and a width of from 3 mm to 6 mm, for example.

In the present embodiment, one of the first lug grooves 41 and two of the fifth lug grooves 45 are alternately arranged in the tire circumferential direction. By disposing the fifth lug grooves 45, which have the starting ends thereof spaced apart from the first inner circumferential groove 33, between the first lug grooves 41, which divide the inner land portion 53 in the tire circumferential direction, strength of the blocks of the inner land portion 53 can be maintained.

The plurality of sixth lug grooves 46 are disposed with a starting end at a position spaced outwardly apart from the second outer circumferential groove 32 in the tire width direction and extend outward in the tire width direction. Specifically, the angle formed between the sixth lug grooves 46 and the tire width direction is preferably from 5 degrees to 20 degrees. The distance from the starting end of the sixth lug grooves 46 to the second outer circumferential groove 32 is preferably from 15% to 20% of the distance from the second outer circumferential groove 32 to the outer ground contact edge E1. The sixth lug grooves 46 preferably have a depth of from 1 mm to 7 mm, for example, and a width of from 4 mm to 6 mm, for example.

The starting end of each sixth lug groove 46 is spaced apart from the second outer circumferential groove 32, thus an outer shoulder land portion 54 located outward of the second outer circumferential groove 32 in the tire width direction is formed as an annular rib continuous in the tire circumferential direction.

In the present embodiment, as illustrated in FIG. 2, the land portions (outer half of the center land portion 51, the outer land portion 52, and the outer shoulder land portion 54) located outward of the tire center line CL in the tire width direction (right side in FIG. 2) are formed as ribs continuous in the tire circumferential direction. As a result, steering stability in the outer portions in the tire width direction can be increased. Additionally, the third lug grooves 43 extend from the starting ends to the trailing side in the tire rotation direction and communicate with the first inner circumferential groove 33, and the fourth lug grooves 44 extend from the starting ends to the trailing side in the tire rotation direction and communicate with the second outer circumferential groove 32. As a result, water drainage performance can be improved.

On the other hand, land portions (inner half of the center land portion 51, the inner land portion 53, and the inner shoulder land portion 55) located inward of the tire center line CL in the tire width direction (left side in FIG. 2) are formed as blocks divided in the tire circumferential direction. As a result, the number of edges in the land portions can be increased. Additionally, snow column shear force imparted by the first lug grooves (third lug grooves) 41 and the fifth lug grooves 45 can be increased, enabling braking performance on snow to be increased.

### Second Embodiment

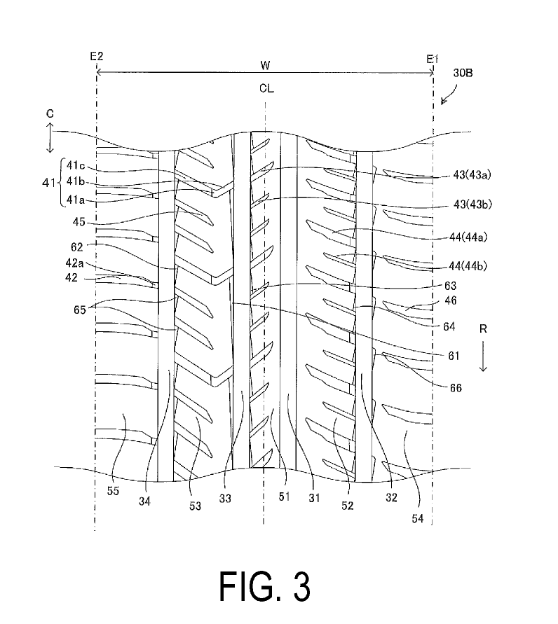

FIG. 3 is a developed view illustrating a tread pattern 30B according to a second embodiment of the present technology. Note that components that are the same as those of the first embodiment are given the same reference sign and the description thereof is omitted.

In the present embodiment, a corner portion formed between the road contact surface of the inner land portion 53 and the first inner circumferential groove 33 is chamfered to form a first inclined surface 61. The first inclined surface 61 is disposed at the corner portion with an acute angle formed between the first inner circumferential groove 33 and the first inclined portion 41b of the first lug groove 41 and meets the road contact surface of the inner land portion 53, the side wall of the first inner circumferential groove 33, and the side wall of the first inclined portion 41b of the first lug groove 41.

By forming a chamfer in this manner, the number of edges is increased by the edge formed by the first inclined surface 61 and the road contact surface of the inner land portion 53, the edge formed by the first inclined surface 61 and the side wall of the first inner circumferential groove 33, and the edge formed by the first inclined surface 61 and the side wall of the first lug groove (third lug groove) 41. As a result, braking performance can be improved.

To obtain the effects described above, the first inclined surface 61 preferably has a width in the tire width direction of from 2 mm to 4 mm, a length in the tire circumferential direction of from 30 mm to 50 mm, and a depth in the tire radial direction of from 1 mm to 2 mm.

Additionally, in the present embodiment, a corner portion formed between the road contact surface of the inner land portion 53 and the second inner circumferential groove 34 is chamfered to form a second inclined surface 62. The second inclined surface 62 is disposed at the corner portion with an acute angle formed between the second inner circumferential groove 34 and the second inclined portion 41c of the first lug groove 41 and meets the road contact surface of the inner land portion 53, the side wall of the second inner circumferential groove 34, and the side wall of the second inclined portion 41c of the first lug groove 41. By forming a chamfer in this manner, the number of edges is increased by the edge formed by the second inclined surface 62 and the road contact surface of the inner land portion 53, the edge formed by the second inclined surface 62 and the side wall of the second inner circumferential groove 34, and the edge formed by the second inclined surface 62 and the side wall of the second inclined portion 41c. As a result, braking performance can be improved.

To obtain the effects described above, the second inclined surface 62 preferably has a width in the tire width direction of from 1 mm to 3 mm, a length in the tire circumferential direction of from 10 mm to 20 mm, and a depth in the tire radial direction of from 1 mm to 2 mm.

Additionally, in the present embodiment, a corner portion formed between the road contact surface of the center land portion 51 and the side wall of the first inner circumferential groove 33 is chamfered to form a third inclined surface 63. The third inclined surface 63 is disposed at the corner portion with an acute angle formed between first inner circumferential groove 33 and the third lug groove 43 and meets the road contact surface of the center land portion 51, the side wall of the first inner circumferential groove 33, and the side wall of the third lug groove 43. By forming a chamfer in this manner, the number of edges is increased by the edge formed by the third inclined surface 63 and the road contact surface of the center land portion 51, the edge formed by the third inclined surface 63 and the side wall of the first inner circumferential groove 33, and the edge formed by the third inclined surface 63 and the side wall of the third lug groove 43. As a result, braking performance can be improved.

To obtain the effects described above, the third inclined surface 63 preferably has a width in the tire width direction of from 1 mm to 3 mm, a length in the tire circumferential direction of from 10 mm to 20 mm, and a depth in the tire radial direction of from 1 mm to 2 mm.

Additionally, in the present embodiment, a corner portion formed between the road contact surface of the outer land portion 52 and the side wall of the second outer circumferential groove 32 is chamfered to form a fourth inclined surface 64. The fourth inclined surface 64 is disposed at the corner portion with an acute angle formed between second outer circumferential groove 32 and the fourth lug groove 44 and meets the road contact surface of the outer land portion 52, the side wall of the second outer circumferential groove 32, and the side wall of the fourth lug groove 44. By forming a chamfer in this manner, the number of edges is increased by the edge formed by the fourth inclined surface 64 and the road contact surface of the outer land portion 52, the edge formed by the fourth inclined surface 64 and the side wall of the second outer circumferential groove 32, and the edge formed by the fourth inclined surface 64 and the side wall of the fourth lug groove 44. As a result, braking performance can be improved.

To obtain the effects described above, the fourth inclined surface 64 preferably has a width in the tire width direction of from 1 mm to 3 mm, a length in the tire circumferential direction of from 7 mm to 15 mm, and a depth in the tire radial direction of from 1 mm to 2 mm.

Additionally, in the present embodiment, a corner portion formed between the road contact surface of the inner land portion 53 and the side wall of the second inner circumferential groove 34 is chamfered to form a fifth inclined surface 65. The fifth inclined surface 65 is disposed at the corner portion with an acute angle formed between second inner circumferential groove 34 and the fifth lug groove 45 and meets the road contact surface of the inner land portion 53, the side wall of the second inner circumferential groove 34, and the side wall of the fifth lug groove 45. By forming a chamfer in this manner, the number of edges is increased by the edge formed by the fifth inclined surface 65 and the road contact surface of the inner land portion 53, the edge formed by the fifth inclined surface 65 and the side wall of the second inner circumferential groove 34, and the edge formed by the fifth inclined surface 65 and the side wall of the fifth lug groove 45. As a result, braking performance can be improved.

To obtain the effects described above, the fifth inclined surface 65 preferably has a width in the tire width direction of from 1 mm to 3 mm, a length in the tire circumferential direction of from 10 mm to 20 mm, and a depth in the tire radial direction of from 1 mm to 2 mm.

Additionally, in the present embodiment, notches 66 are disposed in the second outer circumferential groove 32. The notches 66 are disposed at positions that corresponds to the starting ends of the sixth lug grooves 46 and recess outward in the tire width direction from the outer side wall of the second outer circumferential groove 32 in the tire width direction. The notches 66 are also disposed spaced apart from the sixth lug grooves 46. By forming the notches 66 in this manner, the number of edges is increased by those formed by the road contact surface of the outer shoulder land portion 54 and the notches 66. As a result, braking performance can be improved.

To obtain the effects described above, the notches 66 preferably have a width in the tire width direction of from 1 mm to 3 mm, a length in the tire circumferential direction of from 10 mm to 20 mm, and a depth in the tire radial direction of from 1 mm to 2 mm.

### Third Embodiment

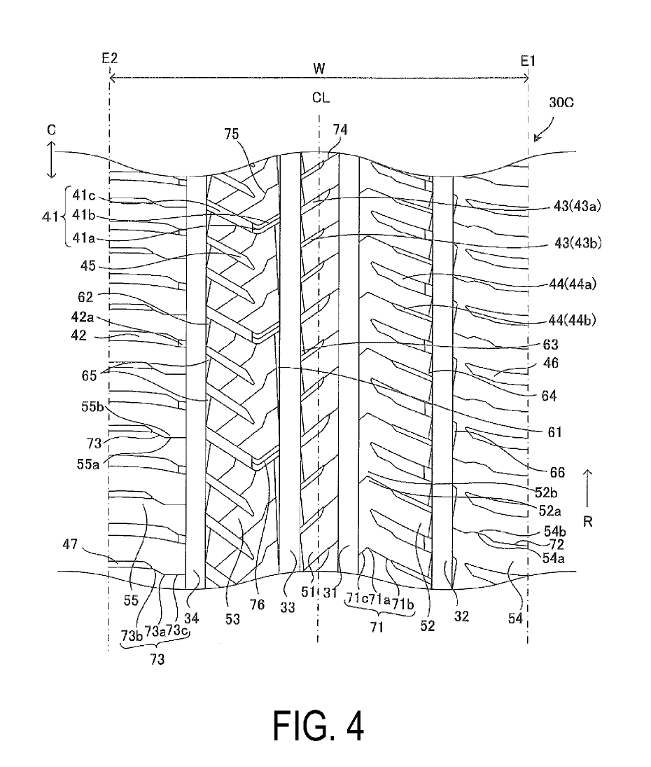

FIG. 4 is a developed view illustrating a tread pattern 30C according to a third embodiment of the present technology. Note that components that are the same as those of the second embodiment are given the same reference sign and the description thereof is omitted.

In the present embodiment, first sipes 71 are disposed communicating with the first outer circumferential groove 31 and the starting ends of the fourth lug grooves 44b, which have a shorter length in the tire width direction of the two types of fourth lug grooves 44a, 44b which differ in length in the tire width direction.

Each first sipe 71 includes a bent portion 71a disposed between the starting end of the fourth lug groove 44b and the first outer circumferential groove 31, a first linear portion 71b extending toward the leading side in the tire rotation direction inward in the tire width direction from the starting end of the fourth lug groove 44b to the bent portion 71a, and a second linear portion 71c extending toward the trailing side in the tire rotation direction inward in the tire width direction from the bent portion 71a to the end portion proximal to the first outer circumferential groove 31. By disposing the first sipes 71, the outer land portion 52 is defined in the tire circumferential direction. In the portions defined by the first sipes 71, a convex portion 52a protruding forward in the tire rotation direction and a concave portion 52b recessed backward in the tire rotation direction are formed.

The first sipes 71 preferably have a depth in the tire radial direction of from 6 mm to 8 mm.

Additionally, in the present embodiment, second sipes 72 are disposed extending from the second outer circumferential groove 32 to the outer ground contact edge E1 in the tire width direction. The second sipes 72 have a curved line shape that includes a plurality of bent portions in the tread surface. By disposing the second sipes 72, the outer shoulder land portion 54 is defined in the tire circumferential direction. In the portions defined by the second sipes 72, a convex portion 54a protruding forward in the tire rotation direction and a concave portion 54b recessed backward in the tire rotation direction are formed.

The second sipes 72 preferably have a depth in the tire radial direction of from 1 mm to 7 mm.

Additionally, in the present embodiment, a seventh lug groove group including a plurality of seventh lug grooves 47 is disposed between the second lug grooves 42 in the tire circumferential direction. Each seventh lug groove 47 has a starting end at a position spaced apart from the second inner circumferential groove 34 and inward in the tire width direction. The seventh lug groove 47 extends from the starting end inward in the tire width direction. Specifically, the distance from the starting end of the seventh lug groove 47 to the second inner circumferential groove 34 is preferably from 35% to 45% of the distance from the second outer circumferential groove 34 to the inner ground contact edge E2. The seventh lug grooves 47 preferably have a depth of from 1 mm to 7 mm, for example, and a width of from 1 mm to 3 mm, for example.

Additionally, in the present embodiment, third sipes 73 are disposed that communicate with the starting ends of the seventh lug grooves 47 and the second inner circumferential groove 34.

Each third sipe 73 includes a bent portion 73a disposed between the starting end of the seventh lug groove 47 and the second inner circumferential groove 34, a first linear portion 73b extending toward the trailing side in the tire rotation direction outward in the tire width direction from the starting end of the seventh lug groove 47 to the bent portion 73a, and a second linear portion 73c extending toward the leading side in the tire rotation direction outward in the tire width direction from the bent portion 73a to the end portion proximal to the second inner circumferential groove 34.

The third sipes 73 preferably have a depth in the tire radial direction of from 6 mm to 8 mm.

By disposing the third sipes 73, the blocks of the inner shoulder land portion 55 are defined in the tire circumferential direction. In the portions defined by the third sipes 73, a concave portion 55a recessed backward in the tire rotation direction and a convex portion 55b protruding forward in the tire rotation direction are formed.

Additionally, in the present embodiment, fourth sipes 74 are disposed in the center land portion 51. The fourth sipes 74 communicate with the starting ends of the third lug grooves 43 and the first outer circumferential groove 31, as illustrated in FIG. 4.

Additionally, in the present embodiment, fifth sipes 75 may be disposed in the inner land portion 53 that intersect with the first lug grooves 41 and the fifth lug grooves 45, as illustrated in FIG. 4. Each fifth sipe 75 is disposed extending toward the leading side in the tire rotation direction outward in the tire width direction from the inner end portion in the tire width direction. Additionally, in the present embodiment, sixth sipes 76 may be disposed in the raised bottom portions (the bent portions 41a and the first inclined portions 41b), which are shallower than the second inclined portions 41c of the first lug grooves 41, in the length direction of the first lug grooves 41, as illustrated in FIG. 4.

In the present embodiment, by disposing the first sipes 71, the second sipes 72, the third sipes 73, the fourth sipes 74, and the fifth sipes 75, the number of edges can be increased, enabling braking performance to be increased.

Additionally, by disposing the convex portions 52a, 54a protruding forward in the tire rotation direction in the outer land portions in the tire width direction via disposing the first sipes 71 and the second sipes 72, steering stability is maintained; and by disposed the concave portion 55a recessed backward in the tire rotation direction in the inner land portions in the tire width direction via disposing the third sipes 73, braking performance can be improved.

### Experiment

In order to investigate the effect of the tread patterns 30A, 30B, 30C of the tire 10 of the present technology, tires were manufactured provided with tread patterns conforming to the specifications indicated in Table 1 and their performances were evaluated.

The tire size was 245/40R18.

In the tires of Comparative Example 1, the center land portion was a rib, the outer land portions and the inner land portions were blocks.

In the tires of Working Example 1, the center land portion and the outer land portions were ribs and the inner land portions were blocks, similar to the configuration illustrated in FIG. 2.

The tires of Working Example 2 had the same configuration as that of Working Example 1 except that inclined surfaces were formed by chamfering, similar to the configuration illustrated in FIG. 3.

The tires of Working Example 3 had the same configuration as that of Working Example 2 except that sipes were formed, similar to the configuration illustrated in FIG. 4.

The performance of the tires made as described above was evaluated as follows for dry steering stability, wet steering stability, and snow braking performance.

### Dry Steering Stability

A passenger vehicle mounted with the tires described above was driven on a dry road surface test course. The driver then performed a sensory evaluation of the steering stability performance.

### Wet Steering Stability

A passenger vehicle mounted with the tires described above was driven on a test course with a 10 mm film of water covering the road surface. The driver then performed a sensory evaluation of the steering stability performance.

### Snow Braking Performance

A passenger vehicle mounted with the tires described above was driven on a test course with a snow covered road surface. The driver then performed a sensory evaluation of the steering stability performance.

For the sensory evaluation, a 100-point standard evaluation was performed for each tire, and the evaluation results of each working example were converted to index values based on the index value of 100 (reference value) for the sensory evaluation results of the conventional example. A higher index value indicates better steering stability and braking performance.

The vehicle used to evaluate the tire performance was a front wheel drive vehicle with a 2000 cc class engine displacement. The internal pressure of all of the front wheels and the rear wheels was set to 230 kPa.

The evaluation results are shown in Table 1.

TABLE 1

| | Comparative | Working | Working | Working |
|---|---|---|---|---|
| | Example 1 | Example 1 | Example 2 | Example 3 |
| Center land portion | Rib | Rib | Rib | Rib |
| form | | | | |
| Outer land portion | Block | Rib | Rib | Rib |
| form | | | | |
| Inner land portion | Block | Block | Block | Block |
| form | | | | |
| Presence of chamfer | No | No | Yes | Yes |
| Presence of sipes | No | No | No | Yes |
| Dry steering stability | 100 | 105 | 105 | 105 |
| Wet steering stability | 100 | 103 | 104 | 105 |
| Snow braking | 100 | 102 | 106 | 110 |
| performance | | | | |

From a comparison of Comparative Example 1 and Working Examples 1 to 3, it can be seen from the results of Working Example 1 that when the outer land portions are formed as ribs, the dry steering stability, wet steering stability, and snow braking performance all improve.

From a comparison of Working Example 1 and Working Example 2, it can be seen that by having chamfers, groove area is increased, and thus wet steering stability and snow braking performance improve.

From a comparison of Working Example 2 and Working Example 3, it can be seen that by disposing sipes, wet steering stability and snow braking performance further improve.

The foregoing has been a detailed description of the pneumatic tire of the present technology. However, the present technology is not limited to the above embodiments, and may be improved or modified in various ways within the scope of the present technology.

1. A pneumatic tire with a specified first side and second side in a tire width direction, the first side being a vehicle outer side when the tire is mounted on a vehicle and the second side being a vehicle inner side, the pneumatic tire comprising:
a tread pattern formed in a tread portion, the tread pattern including:
a first outer circumferential groove which is located to the first side of a tire center line and runs parallel with a tire circumferential direction;
a second outer circumferential groove which is located to the first side of the first outer circumferential groove and runs parallel with the tire circumferential direction;
a first inner circumferential groove which is located to the second side of the tire center line and runs parallel with the tire circumferential direction;
a second inner circumferential groove which is located to the second side of the first inner circumferential groove and runs parallel with the tire circumferential direction;
a first lug groove group including a plurality of first lug grooves which divide in the tire circumferential direction an inner land portion located between the first inner circumferential groove and the second inner circumferential groove; and
a second lug groove group including a plurality of second lug grooves which divide in the tire circumferential direction an inner shoulder land portion located inward in the tire width direction of the second inner circumferential groove;
a center land portion located between the first outer circumferential groove and the first inner circumferential groove, an outer land portion located between the first outer circumferential groove and the second outer circumferential groove, and an outer shoulder land portion located outward of the second outer circumferential groove in the tire width direction being continuous land portions which are continuous in an annular manner in the tire circumferential direction.

2. The pneumatic tire according to claim 1, further comprising
a third lug groove group including a plurality of third lug grooves, each of the third lug grooves having a starting end located between the first outer circumferential groove and the first inner circumferential groove and spaced apart from the first outer circumferential groove and the first inner circumferential groove and communicating with the first inner circumferential groove; wherein
the third lug grooves of the third lug groove group differ from each other in terms of at least one of length in the tire width direction, width in the tire circumferential direction, and depth in a tire radial direction.

3. The pneumatic tire according to claim 1, further comprising
a fourth lug groove group including a plurality of fourth lug grooves, each of the fourth lug grooves having a starting end located between the first outer circumferential groove and the second outer circumferential groove and spaced apart from the first outer circumferential groove and the second outer circumferential groove and communicating with the second outer circumferential groove; wherein
the fourth lug grooves of the fourth lug groove group differ from each other in terms of at least one of length in the tire width direction, width in the tire circumferential direction, and depth in a tire radial direction.

4. The pneumatic tire according to claim 1, further comprising
a fifth lug groove group including a plurality of fifth lug grooves, each of the fifth lug grooves having a starting end located between the first inner circumferential groove and the second inner circumferential groove and spaced apart from the first inner circumferential groove, the second inner circumferential groove, and the first lug grooves and communicating with the second inner circumferential groove.

5. The pneumatic tire according to claim 1, further comprising
a sixth lug groove group including a plurality of sixth lug grooves, each of the sixth lug grooves having a starting end located spaced outwardly apart from the second outer circumferential groove in the tire width direction and extending outward in the tire width direction.

6. The pneumatic tire according to claim 1, wherein
in the inner land portion, a corner portion with an acute angle is formed between the first inner circumferential groove or the second inner circumferential groove and the first lug groove; and
in the corner portion with an acute angle, an inclined surface is formed by chamfering, the inclined surface meeting a road contact surface of the inner land portion, a side wall of the first inner circumferential groove or the second inner circumferential groove, and a side wall of the first lug groove.

7. The pneumatic tire according to claim 2, wherein
in the center land portion, a corner portion with an acute angle is formed between the first inner circumferential groove and the third lug groove; and
in the corner portion with an acute angle, an inclined surface is formed by chamfering, the inclined surface meeting a road contact surface of the center land portion, a side wall of the first inner circumferential groove, and a side wall of the third lug groove.

8. The pneumatic tire according to claim 3, wherein
in the outer land portion, a corner portion with an acute angle is formed between the second outer circumferential groove and the fourth lug groove; and
in the corner portion with an acute angle, an inclined surface is formed by chamfering, the inclined surface meeting a road contact surface of the outer land portion, a side wall of the second outer circumferential groove, and a side wall of the fourth lug groove.

9. The pneumatic tire according to claim 4, wherein
in the inner land portion, a corner portion with an acute angle is formed between the second inner circumferential groove and the fifth lug groove; and
in the corner portion with an acute angle, an inclined surface is formed by chamfering, the inclined surface meeting a road contact surface of the inner land portion, a side wall of the second inner circumferential groove, and a side wall of the fifth lug groove.

10. The pneumatic tire according to claim 5, wherein
in the second outer circumferential groove, notches are disposed at positions in the tire circumferential direction that correspond to inner starting ends of the sixth lug grooves in the tire width direction, the notches recessing outward in the tire width direction from an outer side wall of the second outer circumferential groove in the tire width direction and being spaced inwardly apart from the inner starting ends of the sixth lug grooves in the tire width direction.

11. The pneumatic tire according to claim 3, wherein
the fourth lug groove group includes a long lug groove and a short lug groove with a length in the tire width direction less than that of the long lug groove, the long lug groove and the short lug groove being alternately arranged in the tire circumferential direction; and further including
first sipes which communicate with starting ends of the short lug grooves and the first outer circumferential groove and define the outer land portion in the tire circumferential direction, each of the first sipes including:
a bent portion disposed between the starting end of the short lug groove and the first outer circumferential groove,
a first linear portion which extends in a first direction in a tire rotation direction inward in the tire width direction from the starting end of the short lug groove to the bent portion, and
a second linear portion which extends in a second direction opposite to the first direction in a tire rotation direction inward in the tire width direction from the bent portion to an end portion proximal to the first outer circumferential groove, and
each portion of the outer land portion defined in the tire circumferential direction by the first sipes includes a convex portion which protrudes in the first direction of the tire rotation direction.

12. The pneumatic tire according to claim 1, further comprising
second sipes which extend from the second outer circumferential groove to an outer ground contact edge in the tire width direction, define the outer shoulder land portion in the tire circumferential direction, and have a curved line shape which includes a plurality of bent portions in a tread surface; and wherein each portion of the outer shoulder land portion defined in the tire circumferential direction by the second sipes includes a convex portion which protrudes in the first direction of a tire rotation direction.

13. The pneumatic tire according to claim 1, further comprising
a seventh lug groove group including a plurality of seventh lug grooves, each of the seventh lug grooves having a starting end located between the second lug grooves in the tire circumferential direction and spaced inwardly apart from the second inner circumferential groove in the tire width direction, and extending inward in the tire width direction; and
third sipes which communicate with the starting ends of the seventh lug grooves and the second inner circumferential groove, each of the third sipes including:
a bent portion disposed between the starting end of the seventh lug groove and the second inner circumferential groove,
a first linear portion which extends in the second direction opposite to the first direction in a tire rotation direction outward in the tire width direction from the starting end of the seventh lug groove to the bent portion, and
a second linear portion which extends in the first direction in the tire rotation direction outward in the tire width direction from the bent portion to an end portion proximal to the second inner circumferential groove, and
each portion of the inner shoulder land portion defined in the tire circumferential direction by the third sipes includes a convex portion which protrudes in the second direction of the tire rotation direction.

14. The pneumatic tire according to claim 2, further comprising fourth sipes which communicate with the starting ends of the third lug grooves and the first outer circumferential groove.

15. The pneumatic tire according to claim 1, further comprising fifth sipes disposed between the first inner circumferential groove and the second inner circumferential groove which intersect with the first lug grooves.

16. The pneumatic tire according to claim 1, wherein
a tire rotation direction is predetermined, and each of the first lug grooves include:
a first inclined portion which extends toward a trailing side in the tire rotation direction inward in the tire width direction from the first inner circumferential groove,
a second inclined portion which extends toward the trailing side in the tire rotation direction outward in the tire width direction from the second inner circumferential groove, and
a bent portion where the first inclined portion and the second inclined portion meet.

17. The pneumatic tire according to claim 16, wherein a distance in the tire width direction from the bent portion to the first inner circumferential groove is less than a distance in the tire width direction from the bent portion to the second inner circumferential groove.

18. The pneumatic tire according to claim 16, wherein the second inclined portion and the bent portion are raised bottom portions with a groove depth less than that of the first inclined portion.

19. The pneumatic tire according to claim 18, wherein in the second inclined portion and the bent portion, a sixth sipe is disposed in a length direction of the first lug groove.

20. The pneumatic tire according to claim 1, wherein in an end portion of each second lug groove proximal to the second inner circumferential groove, a raised bottom portion is disposed, the raised bottom portion being shallower than other portions of the second lug groove.
